(19) United States
(12) Patent Application Publication
(10) Pub. No.: US 2006/0045526 A1
(43) Pub. Date: Mar. 2, 2006

(54) Optical communication system

(76) Inventors: Makoto Katayama, Yokohama-shi (JP); Tomohiko Kanie, Yokohama-shi (JP); Michiko Takushima, Yokohama-shi (JP); Takayuki Shimazu, Yokohama-shi (JP); Akira Inoue, Yokohama-shi (JP); Hisao Maki, Yokohama-shi (JP); Masayuki Nishimura, Yokohama-shi (JP)

Correspondence Address: MCDERMOTT WILL & EMERY LLP, 600 13TH STREET, N.W., WASHINGTON, DC, 20005-3096, US

(21) Appl. No.: 11/212,910

(22) Filed: Aug. 29, 2005

Related U.S. Application Data
(60) Provisional application No. 60/606,429, filed on Sep. 2, 2004.

(30) Foreign Application Priority Data
Sep. 2, 2004 (JP) P2004-255837

(51) Int. Cl. H04J 14/00

(52) U.S. Cl. 398/71

(57) ABSTRACT

The present invention relates to an optical communication system of a structure permitting the communication carrier side to select a delivery service content to be finally provided from a terminal in a communication network through an optical fiber to a subscriber home. The optical communication system comprises a terminal as a final repeater in a predetermined communication network for delivering signal light with multiple signal channels multiplexed, to a plurality of subscriber homes; and an optical fiber network with one or more branch points installed between the terminal and the subscriber homes. The terminal includes an optical multiplexer/demultiplexer for multiplexing multiple signal channels included in the signal light, and the branch point is provided with a wavelength selector for selecting at least one of the multiplexed signal channels in accordance with a delivery service content of each subscriber home included in a delivery target group of the terminal and for delivering it to the subscriber home.

### CROSS-REFERENCE TO RELATED APPLICATION

This application claims priority to Provisional Application Ser. No. 60/606,429 filed on Sep. 2, 2004 by the same Applicant, which is hereby incorporated by reference in its entirety.

### BACKGROUND OF THE INVENTION

1. Field of the Invention

The present invention relates to an optical communication system for transmitting signal light in which multiple signal channels of mutually different wavelengths are multiplexed.

2. Related Background Art

Recently, there has been growing multimedia communication as combination of a variety of multimedia such as sound, image, and text information. Among others, users are continuing to increase exponentially in broadband communication to provide the multiplex of the Internet with the data communication service such as e-mail, the video delivery service, and so on. Such multimedia communication is implemented by communication systems making use of metal cables or optical fiber cables, and there exist various systems; for example, the optical communication systems incorporating the optical fiber cables as transmission media include an optical communication system for transmitting digital signals and analog signals in a multiplexed state, an optical communication system for transmitting multiple types of analog signals as assigned to their respective different channels (wavelength bands), an optical communication system for transmitting multiple types of digital signals as assigned to their respective different channels, an optical communication system for transmitting a video signal, a sound signal, and a data signal in a multiplexed state, an optical communication system for transmitting an identical data signal to different subscribers while assigning the data signal to different channels, and so on.

Among the various broadband communication systems, a significant increase is shown, particularly, in the number of users of the FTTH service for delivering information from a terminal in an existing communication network through an optical fiber to each home. This FTTH (Fiber To The Home) service is excellent in terms of communication speed and communication quality and also excellent in service extensibility such as wavelength multiplexing, and is expected as a key communication system taking a major role in widespread use and expansion of the broadband communication. Namely, the current FTTH service is directed to only transmission/reception of digital data signals, but further development to the wavelength division multiplexing service is expected on the basis of optical fiber networks now under development, because the optical fiber has a great feature of capability of simultaneous transmission of multiple wavelengths. For this reason, fingers are pointed at the probability of feasibility of a greater diversity of services, not only the delivery of the digital data signals used in the Internet or the like, but also the delivery of video signals by the analog transmission system, without significant capital expenditure.

FIGS. 4A to 4C are illustrations each showing a schematic configuration of a conventional optical communication system described in OPTRONICS (2004), No. 1, pp. 167-193 (Printed on January, 2004). As shown in this FIG. 4A, the conventional optical communication system is provided with an optical fiber network 30 connecting a communication center 10 as a transmitting station to a subscriber home 20.

The communication center 10 functions as a server for transmitting and receiving a digital data signal S1 used in the data communication service such as the Internet, to and from the subscriber home 20, and also functions as a transmitting station for delivering a subscribed analog video signal S2 to the subscriber home 20. For this purpose, the communication center 10 is equipped with a video signal transmitter 11 for outputting the analog video signal S2, an optical splitter 12 for splitting the analog video signal S2 into signals to be delivered to respective terminals (final repeaters for simultaneously delivering the signals to subscriber homes included in a delivery target group), and an optical multiplexer/demultiplexer 13 for multiplexing the digital data signal S1 and the analog video signal S2.

The optical fiber network 30 is installed between the final repeater (terminal) in an existing upper communication network, such as the Internet, and the subscriber home 20, and a closure including an optical splitter 31 as one or more branch points is set in this optical fiber network 30.

On the other hand, the subscriber home 20 for receiving the multiplexed signals (including the digital data signal S1 and the analog video signal S2) is equipped with a personal computer (PC) 22 as a terminal making use of the digital data signal S1, and a television set (TV) 23, for example, as a terminal making use of the analog video signal S2. This subscriber home 20 is provided with an optical multiplexer/demultiplexer 21 for demultiplexing the received multiplexed signals into the digital data signal S1 and the analog video signal S2.

The optical multiplexer/demultiplexer 13 (21), as shown in FIG. 4B, has a structure in which a dielectric multilayer filter 131 is interposed between two lenses 130, and enables bi-directional transmission/reception of signals of wavelength λ1 (e.g., digital data signals) and also enables interruption of signals of wavelength λ2 (e.g., analog video signals). A well-known example of the optical splitter 12 (31) is of a fiber fused drawing type, as shown in FIG. 4C.

### SUMMARY OF THE INVENTION

The Inventors investigated the conventional optical communication systems capable of providing the FTTH service as described above, and found the following problems. Namely, in the case of the conventional optical communication systems (digital/analog multiplexing systems) for delivering an analog video signal and a digital data signal in a multiplexed state, such as CATV, an optical multiplexer/demultiplexer for separating multiplexed signal channels was set at each subscriber home and the analog video signal was supplied to all the subscriber homes, irrespective of their contractual coverage. Therefore, in order to discriminate subscribers subscribing the video delivery service, from subscribers not subscribing the video delivery service, the communication center delivered the analog video signal in a scrambled state, while the scrambled signal was descrambled at each of the subscriber homes. However, this form of use made the optical communication system itself and the device at each subscriber home more complex, and thus posed the problem that it was an increase factor of cost.

In addition, the conventional optical communication systems such as CATV had the problem that there was no hardware-like scheme for allowing the communication carrier side to select the contents to be delivered. Namely, the analog video signals have an optical power approximately ten or more times greater than the digital data signals, and the presently available subscriber transmission/reception terminals dedicated to the digital data signals sense the analog video signals as noise and cause significant degradation of communication quality. For this reason, at the case that a change is made in the contractual coverage between a service provider and a subscriber, it will become necessary to replace a receiving unit in the subscriber home. Specifically, it was necessary to introduce a function of selecting only light of wavelengths in accordance with the contractual coverage for the subscriber transmission/reception terminal set at the subscriber home (wavelength selecting filter). In this case, however, a function of blocking unnecessary wavelengths has to be added to all the transmission/reception terminals already installed, and it has to be changed every time a change is made in the contractual coverage.

The present invention has been accomplished in order to solve the problems as described above, and an object of the invention is to provide an optical communication system of a structure allowing the communication carrier side to select a delivery service content to be finally provided from a terminal of a communication network through an optical fiber to each subscriber home.

An optical communication system according to the present invention is applicable as an embodiment thereof to the FTTH service for delivering a digital data signal and an analog video signal in a multiplexed state to an arbitrary subscriber home, while connecting the subscriber home through an optical fiber to a final repeater (terminal) in an existing upper communication network; for example, it is also applicable to an optical communication system such as the broadband communication for delivering the digital data signals used in the Internet or the like and the analog video signals used in the video delivery service or the like, an optical communication system for transmitting multiple types of analog signals as assigned to their respective different channels (wavelength bands), an optical communication system for transmitting multiple types of digital signals as assigned to their respective different channels, an optical communication system for transmitting a video signal, a sound signal, and a data signal in a multiplexed state, an optical communication system for transmitting an identical data signal to different subscribers while assigning the data signal to different channels, and so on.

In particular, an optical communication system according to the present invention is characterized in that one or more branch points are provided in an optical fiber network installed between the terminal and the subscriber home and in that these branch points comprise a wavelength selector for selecting at least one of multiplexed signal channels according to each delivery service content of a subscriber home included in a delivery target group and for transmitting the selected channel to the subscriber home. For example, a closure (a protector cover for a cable joint) installed near the subscriber home corresponds to the branch point in this optical fiber network.

Preferably, the wavelength selector is, for example, an optical component having an optical waveguide in which signal light from the optical fiber network propagates, and a wavelength selecting filter for transmitting or reflecting one of the multiplexed signal channels. In this case, the position of the wavelength selecting filter may be changed by hand, or the position of the wavelength selecting filter relative to the optical waveguide may be changed by a driving mechanism.

The wavelength selector may also be an optical component having an optical waveguide in which signal light from the optical fiber network propagates, a wavelength selecting filter an installation position of which is fixed with respect to the optical waveguide, for transmitting or reflecting one of the multiplexed signal channels, and a driving mechanism for changing an installation position of a mirror for reflecting the signal light propagating in the optical waveguide, with respect to the optical waveguide.

In accordance with the present invention, as described above, the wavelength selector for selectively blocking any one of the multiplexed signal channels delivered through the optical fiber network installed between the terminal as the final repeater in the communication system, such as the existing Internet, and the subscriber home is installed at the branch point in the optical closure (protector cover for cable joint) or the like in the optical fiber network, instead of at each subscriber home, and it enables the communication carrier side to readily confirm and capture the contractual coverage and actual service situation on a subscriber-by-subscriber basis and to readily adapt to a change of the contractual coverage.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is an illustration showing a schematic configuration of an optical communication system according to the present invention;

FIGS. 2A and 2B are illustrations each showing a first configuration example of an optical component as a wavelength selector applicable to the optical communication system shown in FIG. 1;

FIGS. 3A and 3B are illustrations each showing a second configuration example of an optical component as a wavelength selector applicable to the optical communication system shown in FIG. 1; and

FIGS. 4A to 4C are illustrations each showing a schematic configuration of a conventional optical communication system.

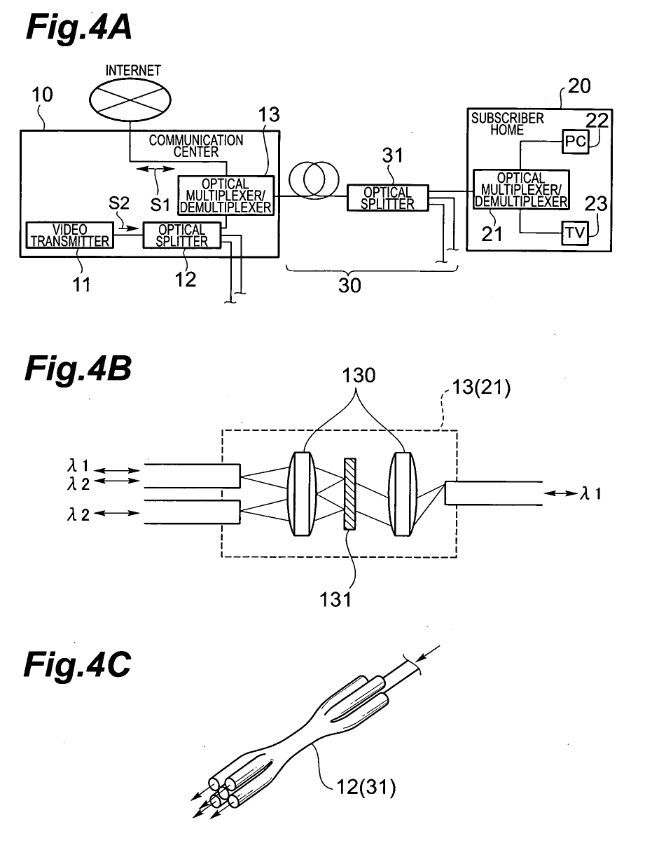

### DETAILED DESCRIPTION OF THE PREFERRED EMBODIMENTS

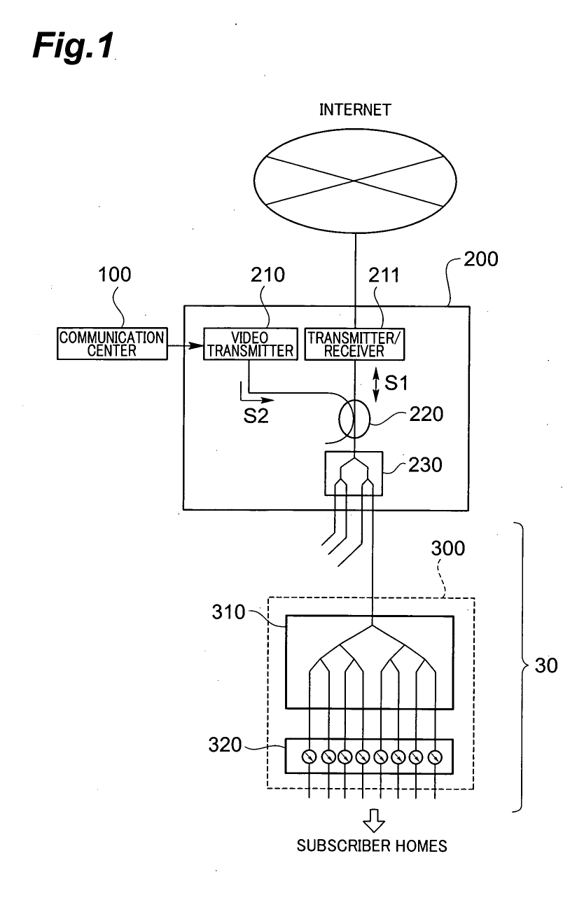

In the following, embodiments of an optical communications system according to the present invention will be explained in detail with reference to FIGS. 1 and 2A to 3B. In the explanation of the drawings, constituents identical to each other will be referred to with numerals identical to each other without repeating their overlapping descriptions.

The optical communication system according to the present invention is applicable, for example, to an optical communication system such as broadband communication for delivering the digital data signals used in the Internet or the like, and the analog video signals used in the video delivery service or the like, an optical communication system for transmitting multiple types of analog signals as assigned to their respective different channels (wavelength bands), an optical communication system for transmitting multiple types of digital signals as assigned to their respective different channels, an optical communication system for transmitting a video signal, a sound signal, and a data signal in a multiplexed state, an optical communication system for transmitting an identical data signal to different subscribers while assigning the data signal to different channels, and so on. In particular, attention is currently being drawn toward the optical communication systems for providing the FTTH service to deliver multiplexed digital data and analog video signals to an arbitrary subscriber home while connecting a final repeater (terminal) in an existing upper communication network to the subscriber home through an optical fiber. An optical communication system to provide the FTTH service will be described below in detail as an optical communication system according to the present invention.

FIG. 1 is an illustration showing a schematic configuration of an optical communication system to provide the FTTH service, as an example of the optical communication system according to the present invention. The optical communication system shown in this FIG. 1 is provided with a terminal 200 being a final repeater in an existing communication system, such as the Internet, and an optical fiber network 30 installed between the terminal 200 and subscriber homes. This optical fiber network 30 is provided with a closure 300 as a branch point located outside the subscriber homes.

The terminal 200 is equipped with a transmitter/receiver 211 for transmitting and receiving digital data signals S1 to and from the existing communication network, such as the Internet, and a video transmitter 210 for guiding an analog video signal S2 from communication center 100 to the optical fiber network 30. The terminal 200 is further provided with a coupler 220 as an optical multiplexer/demultiplexer for multiplexing or demultiplexing the digital data signal S1 from the transmitter/receiver 211 and the analog video signal S2 from the video transmitter 210, and a 1-to-4 splitter 230 for splitting the multiplexed signals from the coupler 220 into four signals to the optical fiber network 30.

In the closure 300 as a branch point of the optical fiber network 30, there are arranged a 1-to-8 splitter 310 for further splitting the incoming multiplexed signals into eight signals, and an optical component 320 as a wavelength selector prepared for respective subscribers. This optical component 320 selects at least one of the digital data signal and analog video signal according to the contractual coverage of each subscriber from each multiplexed signals thus split and transmits it to each subscriber.

In the optical communication system shown in FIG. 1, as described above, the 1-to-4 splitter 230 is provided in the terminal 200, and the 1-to-8 splitter 320 is in the closure 300 in the optical fiber network 30; therefore, one terminal 200 can provide the FTTH service for thirty two subscribers.

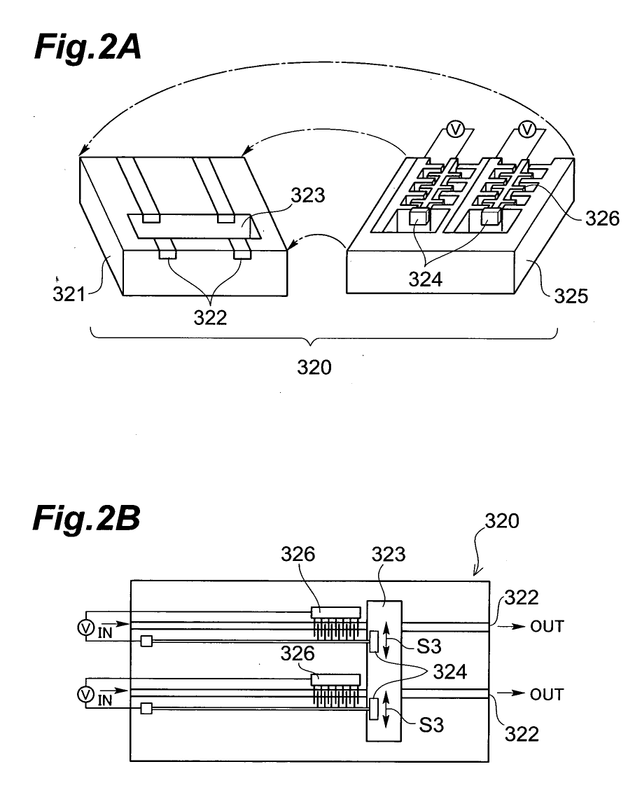

Next, a first configuration example of the optical component 320 as the wavelength selector applied to the optical communication system according to the present invention will be described with reference to FIGS. 2A and 2B. Each of FIGS. 2A and 2B shows a configuration of optical component 320 set in the closure 300 of the optical fiber network 30 in the optical communication system shown in FIG. 1.

For example, the optical component 320, as shown in FIG. 2A, comprises a waveguide substrate 321 having optical waveguides 322 in which multiplexed digital data signal S1 and analog video signal S2 propagate, and a reinforcing plate 325 having an MEMS (Micro-Electro-Mechanical System).

The waveguide substrate 321 is provided with a groove 323 traversing the optical waveguides 322. On the other hand, the MEMS including comb-shaped electrodes 326 is built in the reinforcing plate 325, and the head parts thereof are moved in directions indicated by arrows S3 (see FIG. 2B) by the comb-shaped electrodes 326. A wavelength selecting filter 324 is attached to each of the head parts, and the wavelength selecting filter 324 is housed in the groove 323 when the reinforcing plate 325 is attached to the waveguide substrate 321.

The first configuration example shown in FIGS. 2A and 2B is constructed using the MEMS as a driving mechanism for changing the position of wavelength selecting filter 324 relative to the optical waveguide, but this wavelength selecting filter 324 may also be arranged so that the position thereof is changed by hand. The optical component as the wavelength selector may also comprises an optical waveguide in which signal light from the optical fiber network 30 propagates, a wavelength selecting filter an installation position of which is fixed with respect to the optical waveguide, for transmitting or reflecting either of the multiplexed digital data signal and analog video signal, and a driving mechanism for changing an installation position of a mirror for reflecting the signal light propagating in the optical waveguide, with respect to the optical waveguide.

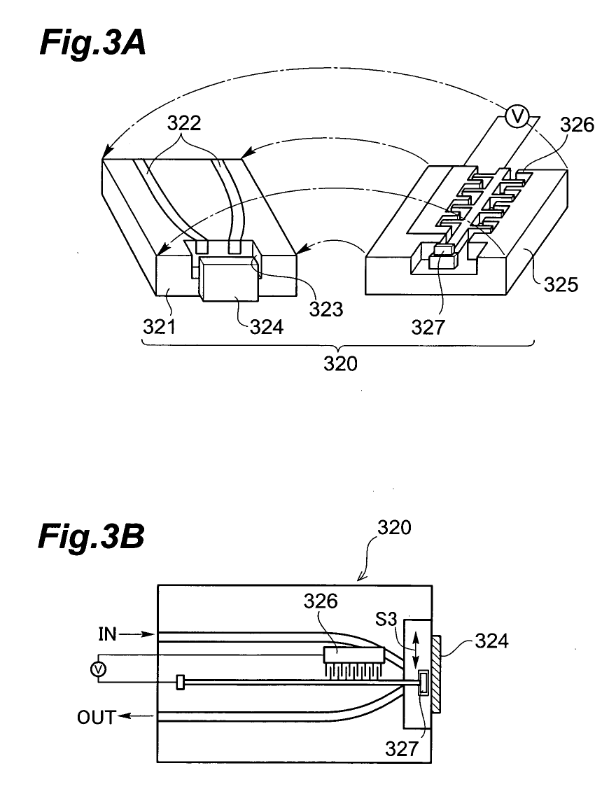

FIGS. 3A and 3B are illustrations each showing a second configuration example of the optical component as the wavelength selector applicable to the optical communication system shown in FIG. 1. This optical component 320, as shown in FIG. 3A, comprises a waveguide substrate 321 having optical waveguides 322 in which multiplexed signals containing multiple wavelengths propagate, and a reinforcing plate 325 having an MEMS.

The waveguide substrate 321 is provided with a groove 323 traversing the optical waveguides 322, and a wavelength selecting filter (included in the wavelength selector) such as a dielectric multilayer filter is fixed at a predetermined location on the waveguide substrate 321 where the light having propagated through the optical waveguide 322 arrives. On the other hand, the MEMS including a comb-shaped electrode 326 is built in the reinforcing plate 325, and the head part thereof is moved in directions indicated by arrows S3 (see FIG. 3B) by this comb-shaped electrode 326. A mirror 327 as a reflecting surface is attached to this head part, and the mirror 327 is housed in the groove 323 when the reinforcing plate 325 is attached to the waveguide substrate 321. In this manner, the MEMS functions as a driving mechanism for changing the position of the mirror 327 relative to the waveguides 322.

As described above, the optical component 320 of the second configuration example is a waveguide type device integrally constructed of the waveguide substrate 321 with the optical waveguides 322 therein, the wavelength selecting filter 324, and the mirror 327, and has the structure enabling further downsizing.

The present invention enables the communication carrier side to select a delivery service content to be finally provided from a terminal of an optical fiber network to each subscriber home, for example, in an optical communication system enabling the broadband communication to multiplex the digital data signals as in the Internet and the analog video signals used in the video delivery service or the like, in an optical communication system for transmitting multiple types of analog signals as assigned to their respective different channels (wavelength bands), in an optical communication system for transmitting multiple types of digital signals as assigned to their respective different channels, in an optical communication system for transmitting a video signal, a sound signal, and a data signal in a multiplexed state, in an optical communication system for transmitting an identical data signal to different subscribers while assigning the data signal to different channels, and so on.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical communication system for transmitting signal light in which a plurality of signal channels of mutually different wavelengths are multiplexed, through an optical fiber, said optical communication system comprising:
a terminal, as a final repeater in a predetermined communication network, for transmitting and receiving the signal light to and from a plurality of subscriber homes, said terminal having an optical multiplexer/demultiplexer for multiplexing the plurality of signal channels;
an optical fiber network having one or more branch points each installed between said terminal and said subscriber homes, said optical fiber network for delivering the multiplexed signal channels from said terminal to said subscriber homes; and
a wavelength selector arranged at least at one of said branch points, for selecting at least one of the plurality of signal channels in accordance with a delivery service content of each subscriber home included in a delivery target group of said terminal and for delivering the selected channel to said subscriber home.

2. An optical communication system according to claim 1, wherein said wavelength selector is an optical component having: an optical waveguide in which the signal light from said optical fiber network propagates; and a wavelength selecting filter for transmitting or reflecting one of the plurality of signal channels included in the signal light.

3. An optical communication system according to claim 2, wherein said optical component has a driving mechanism for changing a position of said wavelength selecting filter with respect to said optical waveguide.

4. An optical communication system according to claim 1, wherein said wavelength selector is an optical component having: an optical waveguide in which the signal light from said optical fiber network propagates; a wavelength selecting filter whose installation position with respect to said the optical waveguide is fixed, for transmitting or reflecting one of the plurality of channels included in the signal light; and a driving mechanism for changing an installation position of a mirror for reflecting the signal light propagating in said optical waveguide, with respect to said optical waveguide.
